(19) United States
(12) Patent Application Publication
(10) Pub. No.: US 2021/0253860 A1
(43) Pub. Date: Aug. 19, 2021

(54) EXTRUSION MOLDING HYDRAULIC COMPOSITION, METHOD FOR MANUFACTURING EXTRUSION-MOLDED BODY, AND EXTRUSION-MOLDED BODY

(71) Applicant: Shin-Etsu Chemical Co., Ltd., Tokyo (JP)

(72) Inventor: Hidekazu KONISHI, Joetsu-shi (JP)

(73) Assignee: Shin-Etsu Chemical Co., Ltd., Tokyo (JP)

(21) Appl. No.: 17/173,301

(22) Filed: Feb. 11, 2021

(30) Foreign Application Priority Data
Feb. 12, 2020 (JP) 2020-021518

(51) Int. Cl. C08L 97/02; C08L 1/28; C08L 23/12

(52) U.S. Cl. CPC C08L 97/02; C08L 23/12; C08L 1/284

(57) ABSTRACT

An extrusion molding hydraulic composition contains: an expansive additive; a water-soluble hydroxyalkylalkyl cellulose; a cement; an aggregate; reinforcing fibers; and water, wherein a weight ratio between the expansive additive and the water-soluble hydroxyalkylalkyl cellulose is 50:50 to 99:1.

### CROSS-REFERENCE TO RELATED APPLICATION

This non-provisional application claims priority under 35 U.S.C. § 119(a) on Patent Application No. 2020-021518 filed in Japan on Feb. 12, 2020, the entire contents of which are hereby incorporated by reference.

### TECHNICAL FIELD

The present invention relates to an extrusion molding hydraulic composition that can be used as a hydraulic composition for siding used in houses, medium- and low-rise buildings, or the like, a method for manufacturing an extrusion-molded body, and an extrusion-molded body.

### BACKGROUND ART

Conventionally, by using asbestos and a water-soluble cellulose ether as additives in an extrusion molding hydraulic composition, a molded article having excellent moldability, surface smoothness, and strength has been obtained, but asbestos is no longer used due to subsequent laws and regulations and the like. Pulp fibers are often used as an alternative to asbestos, but the pulp fibers have poor dispersibility. Therefore, in order to improve the dispersibility of the pulp fibers and strength characteristics and extrusion moldability of the extrusion molding hydraulic composition, it is common to use an increased amount of water-soluble cellulose ether than before.

However, the water-soluble cellulose ether has a setting retardation property with respect to cement. That is, when the water-soluble cellulose ether is used for cement-based extrusion molding, it is necessary to take a long curing time in a step of allowing a molded body to be left-cured to harden a cement composition.

Meanwhile, in order to shorten the curing time, JP-A H09-249438 (Patent Document 1) has proposed a material admixture containing a setting accelerator such as calcium chloride, for cement-based extrusion molding composition containing a water-soluble cellulose ether.

However, by using a setting accelerator such as calcium chloride in combination in the method of Patent Document 1, although the curing time can be shortened, the thermal gelation temperature of the water-soluble cellulose ether is lowered. In summer or the like, when the atmospheric temperature is high, the function of the water-soluble cellulose ether may be impaired, and there is room for improvement.

### CITATION LIST

Patent Document 1: JP-A H09-249438

### DISCLOSURE OF INVENTION

The present invention has been achieved in view of the above circumstances, and it is an object of the present invention to provide an extrusion molding hydraulic composition which can shorten the curing time while ensuring a pot life at a conventional level, a method for manufacturing an extrusion-molded body, and an extrusion-molded body.

As a result of intensive studies in order to solve the above problems, the present inventor has found that by using an expansive additive with respect to an extrusion molding hydraulic composition containing a water-soluble hydroxyalkylalkyl cellulose, an extrusion molding hydraulic composition with a shortened curing time can be obtained while ensuring a pot life at a conventional level, and has completed the present invention.

That is, the present invention provides an extrusion molding hydraulic composition, a method for manufacturing an extrusion-molded body, and an extrusion-molded body described below.

1. An extrusion molding hydraulic composition comprising: an expansive additive; a water-soluble hydroxyalkylalkyl cellulose; cement; an aggregate; reinforcing fibers; and water, wherein a weight ratio of the expansive additive to the water-soluble hydroxyalkylalkyl cellulose is 50:50 to 99:1.
2. The extrusion molding hydraulic composition according to the item 1, wherein the expansive additive is an ettringite-based expansive additive or a lime-based expansive additive.
3. The extrusion molding hydraulic composition according to the item 1 or 2, wherein the water-soluble hydroxyalkylalkyl cellulose is hydroxypropylmethyl cellulose or hydroxyethylmethyl cellulose.
4. The extrusion molding hydraulic composition according to any one of the items 1 to 3, wherein a total amount of the expansive additive and the water-soluble hydroxyalkylalkyl cellulose added is 0.5 to 15 parts by weight per 100 parts by weight of a total of the cement, the aggregate, and the reinforcing fibers.
5. A method for manufacturing an extrusion-molded body comprising the steps of: extrusion-molding the extrusion molding hydraulic composition according to any one of the items 1 to 4 to obtain an extrusion-molded part; curing the extrusion-molded part to obtain a cured extrusion-molded part; and drying the cured extrusion-molded part to obtain an extrusion-molded body.
6. An extrusion-molded body comprising: an expansive additive; a water-soluble hydroxyalkylalkyl cellulose; cement; an aggregate; and reinforcing fibers.

### Advantageous Effects of Invention

According to the present invention, there can be obtained an extrusion molding hydraulic composition that shortens a curing time while ensuring a pot life at a conventional level.

### DESCRIPTION OF PREFERRED EMBODIMENTS

The configuration of one embodiment of the present invention is described below.

Note that the term “curing” herein means concrete curing: “action of keeping temperature and humidity at temperature and humidity required for hardening for a certain period after driving, and performing protection so as not to be affected by harmful effects in order to ensure a required quality such as concrete strength, durability, crack resistance, watertightness, performance to protect a steel material or the like” (Concrete Standard Specification (published by the Japan Society of Civil Engineers)). The curing time means a time until an extrusion-molded part of a hydraulic composition is molded, then cured, and can be transported. Here, in wet air curing (50° C., relative humidity 90% RH), a time until the bending strength of the extrusion-molded part becomes 1 N/mm² or more is used as a criterion for judging the long or short of the curing time. The pot life means a time during which a hydraulic composition maintains toughness to the extent that the hydraulic composition can be extrusion-molded without being solidified, separated, or cracked. Here, in wet air curing (50° C., relative humidity 90% RH), a time until the bending strength of the hydraulic composition becomes 0.2 N/mm² or more is used as a criterion for judging the long or short of the pot life.

### Extrusion Molding Hydraulic Composition

The extrusion molding hydraulic composition according to the present invention is characterized by containing an expansive additive, a water-soluble hydroxyalkylalkyl cellulose, cement, an aggregate, reinforcing fibers and water.

Here, the expansive additive is an expanding material for concrete specified in JIS A6202 (2017), and is an admixture material that generates ettringite, calcium hydroxide, and the like by a hydration reaction when the expansive additive is kneaded with cement and water and expands concrete or mortar. Examples of the expansive additive include an ettringite-based expansive additive, a lime-based expansive additive, and an ettringite-lime composite expansive additive. A commercially available expansive additive can be used. Examples of the ettringite-based expansive additive include Denka CSA #10 (manufactured by Denka Co., Ltd.), and examples of the lime-based expansive additive include Taiheiyo Hyperexpan (manufactured by Taiheiyo Materials Corporation). As such an expansive additive, any one type selected from the above expansive additives may be used singly, or two or more types thereof may be used, if necessary.

The mean particle size of the expansive additive is preferably 1 to 50 μm, and more preferably 1 to 25 μm from a viewpoint of shortening the curing time.

The mean particle size of the expansive additive can be determined by performing measurement using a laser diffraction method particle size distribution measuring device Mastersizer 3000 (manufactured by Malvern Instruments) by a dry method according to the Fraunhofer diffraction theory under conditions of a dispersion pressure of 2 bar and a scattering intensity of 2 to 10%, and calculating a diameter corresponding to a 50% cumulative value of a volume-based cumulative distribution curve.

The degree of substitution (DS) of an alkoxy group in the water-soluble hydroxyalkylalkyl cellulose is preferably 1.2 to 1.8, more preferably 1.3 to 1.7, and still more preferably 1.4 to 1.6 from viewpoints of a setting retardation property and thermal gelation.

The number of moles substituted (MS) of a hydroxyalkoxy group in the water-soluble hydroxyalkylalkyl cellulose is preferably 0.05 to 0.6, more preferably 0.1 to 0.5, and still more preferably 0.15 to 0.4 from a viewpoint of high-temperature solubility during extrusion molding.

Note that the DS of the alkoxy group in the water-soluble hydroxyalkylalkyl cellulose indicates the degree of substitution, and means the average number of alkoxy groups per unit of anhydrous glucose. The MS of the hydroxyalkoxy group in the water-soluble hydroxyalkylalkyl cellulose indicates molar substitution, and means the average number of moles of hydroxyalkoxy groups per mole of anhydrous glucose. The DS of the alkoxy group and the MS of the hydroxyalkoxy group in the water-soluble hydroxyalkylalkyl cellulose can be determined by converting values that can be measured by a degree of substitution analysis method of hypromellose (hydroxypropylmethyl cellulose) described in the 17th revised Japanese Pharmacopoeia.

The viscosity of a 1% by weight water-soluble hydroxyalkylalkyl cellulose aqueous solution at 20° C. is preferably 1,000 to 50,000 mPa·s, more preferably 1,500 to 40,000 mPa·s, and still more preferably 3,000 to 30,000 mPa·s from a viewpoint of extrusion moldability.

Note that the viscosity of the 1% by weight water-soluble hydroxyalkylalkyl cellulose aqueous solution at 20° C. can be measured using a B-type viscometer under a measurement condition of 12 rpm (the same applies to Examples).

Examples of the type of water-soluble hydroxyalkylalkyl cellulose include hydroxypropylmethyl cellulose (HPMC) and hydroxyethylmethyl cellulose (HEMC). Specific examples of the water-soluble hydroxyalkylalkyl cellulose used in the present invention include hydroxypropylmethyl cellulose (HPMC) in which the MS of a hydroxypropoxy group is 0.05 to 0.6, the DS of a methoxy group is 1.2 to 1.8, and the viscosity of a 1% by weight aqueous solution at 20° C. is 1,000 to 50,000 mPa·s, and hydroxyethylmethyl cellulose (HEMC) in which the MS of a hydroxyethoxy group is 0.05 to 0.6, the DS of a methoxy group is 1.2 to 1.8, and the viscosity of a 1% by weight aqueous solution at 20° C. is 1,000 to 50,000 mPa·s.

The total amount of the expansive additive and the water-soluble hydroxyalkylalkyl cellulose added is preferably 0.5 to 15 parts by weight, more preferably 1 to 10 parts by weight, and still more preferably 2.5 to 9 parts by weight per 100 parts by weight of the total of the cement, the aggregate, and the reinforcing fibers from a viewpoint of shortening the curing time. Note that of these, the amount of water-soluble hydroxyalkylalkyl cellulose added is preferably 0.5 parts by weight or more.

A weight ratio of the expansive additive to the water-soluble hydroxyalkylalkyl cellulose is 50:50 to 99:1, preferably 60:40 to 97:3, and more preferably 65:35 to 95:5 from a viewpoint of shortening the curing time.

Examples of the cement include ordinary Portland cement, high-early-strength Portland cement, blast furnace cement, moderate heat Portland cement, fly ash cement, alumina cement and silica cement.

It is preferable to appropriately select cement from the above cements depending on an intended use, and any one type selected from the above cements may be used singly, or two or more types thereof may be used, if necessary. Note that a commercially available cement can be used.

The amount of cement added to the extrusion molding hydraulic composition is preferably 20 to 80 parts by weight, and more preferably 25 to 50 parts by weight per 100 parts by weight of the total of the cement, the aggregate, and the reinforcing fibers from a viewpoint of bending strength of an extrusion-molded body.

Examples of the aggregate include an admixture and a lightweight aggregate.

Among these, examples of the admixture include silica stone powder and fly ash. Examples of the lightweight aggregate include pearlite, hollow microspheres, and styrene beads. The hollow microspheres may be an organic substance such as an acrylonitrile-based substance or a polyvinylidene chloride-based substance, or may be an inorganic substance such as a shirasu balloon.

It is preferable to appropriately select an aggregate from the above aggregates depending on an intended use, and any one type selected from the above aggregates may be used singly, or two or more types thereof may be used, if necessary. Note that a commercially available aggregate can be used.

The amount of aggregate added to the extrusion molding hydraulic composition is preferably 10 to 80 parts by weight, and more preferably 20 to 70 parts by weight per 100 parts by weight of the total of the cement, the aggregate, and the reinforcing fibers from a viewpoint of durability of an extrusion-molded body.

A weight ratio of the cement and the aggregate is preferably 10:90 to 99:1, and more preferably 20:80 to 99:1 from a viewpoint of the bending strength of an extrusion-molded body.

Furthermore, the reinforcing fibers are roughly classified into organic fibers and inorganic fibers.

Examples of the organic fibers include pulp fibers and synthetic fibers. Among these fibers, examples of the pulp fibers include hardwood pulp fibers, softwood pulp fibers, linter pulp fibers, and used paper. The average fiber length of the pulp fibers is preferably 0.1 to 5 mm from a viewpoint of bending strength. The average fiber length of the pulp fibers can be measured by a scanning electron microscope.

Examples of the synthetic fibers include polypropylene fibers, vinylon fibers, and acrylic fibers. The fiber length of the synthetic fibers is preferably 0.5 to 30 mm from a viewpoint of bending strength. The fiber length of the synthetic fibers can be measured by a scanning electron microscope.

Examples of the inorganic fibers include sepiolite, wollastonite, and attapulgite.

It is preferable to appropriately select reinforcing fibers from the above reinforcing fibers depending on an intended use, and any one type selected from the above reinforcing fibers may be used singly, or two or more types thereof may be used, if necessary. Note that commercially available reinforcing fibers can be used.

The amount of reinforcing fibers added to the extrusion molding hydraulic composition is preferably 0.01 to 15 parts by weight, and more preferably 0.1 to 10 parts by weight per 100 parts by weight of the total of the cement, the aggregate, and the reinforcing fibers from a viewpoint of the bending strength of an extrusion-molded body.

Examples of the water include tap water and seawater, but tap water is preferable from a viewpoint of preventing salt damage.

The amount of water added to the extrusion molding hydraulic composition is preferably 10 to 75 parts by weight, and more preferably 15 to 70 parts by weight per 100 parts by weight of the total of the cement, the aggregate, and the reinforcing fibers from viewpoints of the extrusion moldability of the extrusion molding hydraulic composition and the bending strength of an extrusion-molded body.

For the extrusion molding hydraulic compositions, a semi-synthetic water-soluble polymer such as modified starch, a synthetic water-soluble polymer such as polyvinyl alcohol, polyacrylamide, polyethylene glycol, or polyethylene oxide, or a thickener such as a fermented polysaccharide such as welan gum may be used, if necessary, from a viewpoint of the extrusion moldability of the extrusion molding hydraulic composition.

For the extrusion molding hydraulic composition, gypsum such as dihydrate gypsum, hemihydrate gypsum, or anhydrous gypsum may be used, if necessary, from a viewpoint of the strength of the extrusion molding hydraulic composition.

Furthermore, for the extrusion molding hydraulic composition, a setting accelerator such as calcium chloride, lithium chloride, or calcium formate, a setting retarder such as sodium citrate or sodium gluconate, a surfactant such as a polycarboxylic acid-based water reducing agent (dispersant) or a melamine-based water reducing agent (dispersant), or the like may be used, if necessary, from a viewpoint of controlling fresh physical properties of the extrusion molding hydraulic composition immediately after manufacture.

A thickener, gypsum, a setting accelerator, a setting retarder, and a surfactant can be used in ordinary amounts as long as the effects of the present invention are not impaired.

Next, a method for manufacturing the extrusion molding hydraulic composition is described.

The extrusion molding hydraulic composition of the present invention can be manufactured by a method for manufacturing an extrusion molding hydraulic composition, the method including at least: a first step of mixing an expansive additive, a water-soluble hydroxyalkylalkyl cellulose, cement, an aggregate, and reinforcing fibers to obtain a first mixture; a second step of mixing the first mixture with water to obtain a second mixture; and a third step of kneading the second mixture to obtain an extrusion molding hydraulic composition.

Here, mixing in the first step can be performed using, for example, a pan-type mixer equipped with an agitator (stirring blade). The rotation speed of the pan in the pan-type mixer is preferably 5 to 18 rpm from a viewpoint of dispersion of the reinforcing fibers. The rotation speed of the agitator in the pan-type mixer is preferably 200 to 700 rpm from a viewpoint of dispersion of the reinforcing fibers.

Note that the order of adding the expansive additive, the water-soluble hydroxyalkylalkyl cellulose, the cement, the aggregate, and the reinforcing fibers is not particularly limited.

The mixing time in the first step is preferably 0.5 to 5 minutes from a viewpoint of suppressing breakage of the reinforcing fibers.

Mixing in the second step can be performed using, for example, a pan-type mixer equipped with an agitator (stirring blade). The rotation speed of the pan in the pan-type mixer is preferably 10 to 18 rpm from a viewpoint of uniform dispersion of water. The rotation speed of the agitator in the pan-type mixer is preferably 200 to 700 rpm from a viewpoint of uniform dispersion of water.

The mixing time in the second step is preferably 0.5 to 5 minutes from a viewpoint of suppressing breakage of the reinforcing fibers.

Kneading in the third step can be performed using, for example, a kneader-ruder equipped with a kneader blade and a ruder screw. The rotation speed of the kneader blade in the kneader-ruder is preferably 10 to 40 rpm from a viewpoint of dissolving the water-soluble hydroxyalkylalkyl cellulose. The rotation speed of the ruder screw in the kneader-ruder is preferably 10 to 30 rpm from a viewpoint of dissolving the water-soluble hydroxyalkylalkyl cellulose.

It is desirable to control the temperature during kneading in the third step using a jacket or the like such that the temperature of the extrusion molding hydraulic composition is preferably 15 to 45° C. from a viewpoint of the plasticity of an extrusion-molded part.

The kneading time in the third step is preferably 1 to 15 minutes from a viewpoint of reducing the molecular weight of the water-soluble hydroxyalkylalkyl cellulose.

The extrusion molding hydraulic composition of the present invention obtained as described above is preferably used in a method for manufacturing an extrusion-molded body below.

According to the extrusion molding hydraulic composition of the present invention obtained as described above, the curing time of an extrusion-molded part manufactured using the extrusion molding hydraulic composition can be shortened as compared with a conventional curing time while ensuring a pot life at a conventional level.

### Method for Manufacturing Extrusion-Molded Body

Next, a method for manufacturing an extrusion-molded body of the present invention is described.

The method for manufacturing an extrusion-molded body of the present invention is characterized by including at least: a step of extrusion-molding the extrusion molding hydraulic composition of the present invention described above to obtain an extrusion-molded part; a step of curing the extrusion-molded part to obtain a cured extrusion-molded part; and a step of drying the cured extrusion-molded part to obtain an extrusion-molded body.

Note that the extrusion-molded part herein means a thing immediately after extrusion molding of the extrusion molding hydraulic composition and a thing that is obtained by curing the thing immediately after extrusion molding and is in the middle of a solidification process (hydration reaction of a cement). The extrusion-molded body means a hardened thing obtained by solidifying the extrusion-molded part.

Here, extrusion molding can be performed using an extrusion molding machine. For example, it is only required to perform molding into a required shape with a die disposed in a discharge portion using a vacuum extrusion molding machine equipped with an auger screw and a pug screw. The rotation speed of the auger screw in the vacuum extrusion molding machine is preferably 10 to 30 rpm from a viewpoint of the smoothness of a surface of an extrusion-molded part. The rotation speed of the pug screw in the vacuum extrusion molding machine is preferably 10 to 30 rpm from a viewpoint of the smoothness of a surface of an extrusion-molded part.

The vacuum extrusion molding machine evacuates a material that has been put therein under reduced pressure. The gauge pressure at this time is preferably −0.080 to −0.100 MPa from a viewpoint of the bending strength of an extrusion-molded body.

It is desirable to control the temperature during extrusion molding in the step of obtaining an extrusion-molded part using a jacket or the like such that the temperature of the extrusion-molded part is preferably 15 to 45° C. from a viewpoint of the plasticity of the extrusion-molded part.

Examples of a curing method include atmospheric pressure steam curing, wet air curing, and high-pressure steam curing. More specifically, it is preferable to perform either atmospheric pressure steam curing or wet air curing, treat the extrusion-molded part until the extrusion-molded part has a transportable strength, and then further perform high-pressure steam curing (additional curing).

The curing temperature in wet air curing is preferably 20 to 70° C. from a viewpoint of exhibiting the strength of the extrusion-molded part. The relative humidity in wet air curing is preferably 80 to 100% RH from a viewpoint of the surface smoothness of the extrusion-molded part. By using the extrusion molding hydraulic composition of the present invention, the curing time can be shortened as compared with a case of conventional extrusion molding, and for example, the curing time in wet air curing (50° C., relative humidity 90% RH) can be about five to eight hours.

The pressure in high-pressure steam curing is preferably 0.5 to 1.4 MPa, and more preferably 0.6 to 1.2 MPa from a viewpoint of accelerating exhibition of the strength of the extrusion-molded part. The curing temperature in high-pressure steam curing is preferably 150 to 190° C., and more preferably 160 to 180° C. from a viewpoint of accelerating exhibition of the strength of the extrusion-molded part. The additional curing time in high-pressure steam curing is preferably six to twelve hours, and more preferably eight to ten hours from a viewpoint of accelerating exhibition of the strength of the extrusion-molded part.

Drying can be performed using a dryer. The drying temperature is preferably 100 to 150° C. from a viewpoint of drying efficiency. The drying time is preferably 0.5 to 48 hours from a viewpoint of accelerating exhibition of strength.

### Extrusion-Molded Body

The extrusion-molded body of the present invention is characterized by containing at least an expansive additive, a water-soluble hydroxyalkylalkyl cellulose, cement, an aggregate, and reinforcing fibers. This extrusion-molded body is preferably manufactured by the above-described method for manufacturing an extrusion-molded body of the present invention.

The water content of the extrusion-molded body is preferably 8% by weight or less, and more preferably 5% by weight or less from a viewpoint of bending strength. Note that the water content of the extrusion-molded body is measured according to JIS A5441 (the same applies to Examples).

### EXAMPLES

Hereinafter, the present invention is described more specifically with reference to Examples and Comparative Examples, but the present invention is not limited to the Examples.

### Examples 1 to 11 and Comparative Examples 1 to 4

### <Material Used>

The following materials were used as an extrusion molding hydraulic composition.

(I) Expansive additive:

Physical properties and composition are illustrated in Table 1.
A: Etringite-based expansive additive:
   Denka CSA #10 (manufactured by Denka Co., Ltd.)
B: Lime-based expansive additive:
   Taiheiyo Hyperexpan (manufactured by Taiheiyo Materials Corporation)
      (II) Water-soluble hydroxyalkylalkyl cellulose:

Physical properties are illustrated in Table 2.

### (III) Cement:

Ordinary Portland cement (manufactured by Taiheiyo Cement Corporation)

### (IV) Aggregate:

Silica stone powder, 250 mesh sieve product (manufactured by Maruesu Co., Ltd.)
Pearlite, N-3 (manufactured by Hattori Co., Ltd.)
   (V) Reinforcing fibers:
Hardwood pulp fibers, average fiber length 1.5 mm
   (manufactured by Oji Seitai Co., Ltd.)
Polypropylene fibers, 13 dtex (decitex), fiber length 6 mm
   (manufactured by Hagihara Industries Inc.)
      (VI) Water: Tap water

TABLE 1

| | | Mean | | | | | | | | |
|---|---|---|---|---|---|---|---|---|---|---|
| | | particle | Ignition | | | | | | | |
| | | size | loss | Composition (%) | | | | | | |
| Type | Trade name | (μm) | (%) | SiO₂ | Al₂O₃ | Fe₂O₃ | CaO | MgO | SO₃ | f-CaO |
| A | Denka CSA #10 | 17.4 | 2.3 | 1.5 | 13.5 | 0.6 | 51.8 | 1.4 | 29.0 | 19.8 |
| B | Taiheiyo Hyperexpan | 16.5 | 0.9 | 4.8 | 1.2 | 0.8 | 76.3 | 0.6 | 15.4 | 50.0 |

* In Table, “f-CaO” indicates unreacted free calcium oxide.

TABLE 2

| | | | | Viscosity (1% by weight |
|---|---|---|---|---|
| | | | | aqueous solution) |
| Sample No. | Type | DS | MS | (mPa·s) |
| 1 | HPMC | 1.5 | 0.18 | 18,000 |
| 2 | HEMC | 1.5 | 0.28 | 16,500 |

* In Table, “HPMC” indicates hydroxypropylmethyl cellulose, and “HEMC” indicates hydroxyethylmethyl
cellulose.

### <Equipment Used and Conditions>

(1) Mixer: Model MZ-50 manufactured by MIG Co., Ltd.
Rotation speed of pan: 13 rpm, Rotation speed of agitator: 500 rpm
   (2) Kneader-ruder: Model NR-25 manufactured by MIG Co., Ltd.
Rotation speed of kneader blade: 30 rpm, Rotation speed of ruder screw: 15 rpm
   (3) Vacuum extrusion molding machine: MIG-075 manufactured by MIG Co., Ltd.
Rotation speed of auger screw: 20 rpm, Rotation speed of pug screw: 20 rpm
Gauge pressure: −0.098 MPa

### <Manufacture of Extrusion Molding Hydraulic Composition>

Among the materials used, materials other than water were put into the mixer and mixed for four minutes to obtain the first mixture. Subsequently, a predetermined amount of water was added to the first mixture in the mixer, and the resulting mixture was mixed for two minutes while being stirred to obtain the second mixture. Thereafter, the second mixture was transferred to a kneader-ruder and kneaded for four minutes to obtain an extrusion molding hydraulic composition. Table 3 illustrates the amounts of the components (above-described materials used) added at this time.

Note that the jacket temperature in the kneader-ruder was set such that the temperature of the extrusion molding hydraulic composition was 25° C.

### <Evaluation>

### 1. Evaluation of Extrusion Moldability

The obtained extrusion molding hydraulic composition was put into the above-described vacuum extrusion molding machine equipped with the rectangular die (molding dimensions 14×120 mm in vertical and horizontal), and was subjected to extrusion molding until the length of an extrusion-molded part became 3 m. Presence or absence of cracks and meandering of the extrusion-molded part during extrusion molding was visually confirmed. Note that the jacket temperature in the vacuum extrusion molding machine was set such that the temperature of the extrusion-molded part was 25° C.

### 2. Pot Life and Curing Time of Extrusion-Molded Part

The obtained extrusion molding hydraulic composition was put into the above-described vacuum extrusion molding machine equipped with the rectangular die (molding dimensions 20×40 mm in vertical and horizontal), and was subjected to extrusion molding. The resulting part was cut to a length of 150 mm to manufacture an extrusion-molded part sample. Note that the jacket temperature in the vacuum extrusion molding machine was set such that the temperature of the extrusion-molded part was 25° C.

Subsequently, the manufactured extrusion-molded part sample was cured in a constant temperature and humidity machine (TPAV-120-20 manufactured by Isuzu Seisakusho Co., Ltd.) at 50° C. and relative humidity of 90% RH, and bending strength was measured every 30 minutes. At this time, an elapsed time that the bending strength became 0.2 N/mm² or more was defined as a pot life, and an elapsed time that the bending strength became 1 N/mm² or more, at which a cured part can be easily transported, was defined as a curing time.

Note that a compression tester ACA-20S manufactured by Maekawa Testing Machine Mfg. Co., Ltd. was used to measure bending strength with 2-point support (distance 10 cm) and 1-point central loading.

### 3. Evaluation of Extrusion-Molded Body

An extrusion-molded part sample (height 20 mm, width 40 mm, length 150 mm) manufactured in a similar manner to the above item 2 was subjected to wet air curing for 10 hours in a constant temperature and humidity machine (TPAV-120-20 manufactured by Isuzu Seisakusho Co., Ltd.) at 50° C. and relative humidity of 90% RH. Thereafter, the sample was subjected to high-pressure steam curing for eight hours under a pressure of 0.6 MPa using an autoclave (autoclave CA type for cement curing manufactured by Kurihara Seisakusho Co., Ltd.) at 160° C. Subsequently, the sample was dried for 24 hours in a blower dryer (blower fixed temperature and constant temperature machine DKN812 type manufactured by Yamato Scientific Co., Ltd.) at 105° C. to obtain an extrusion-molded body. The bending strength of the obtained extrusion-molded body was measured using a compression tester ACA-20S manufactured by Maekawa Testing Machine Mfg. Co., Ltd. with 2-point support (distance 10 cm) and 1-point central loading as in the case of the above extrusion-molded part.

Results thereof are illustrated in Table 3.

TABLE 3

| | | | | Example | | | | | | | |
|---|---|---|---|---|---|---|---|---|---|---|---|
| | | | | 1 | 2 | 3 | 4 | 5 | 6 | 7 | 8 |
| Hydraulic | (I) Expansive | | A | 1.8 | 2.1 | 2.4 | | | | 2.1 | 4.2 |
| compo- | additive | | B | | | | | 2.1 | 5.4 | 6.3 | |
| sition | (II) Water-soluble | | HPMC | | 1.2 | 0.9 | 0.6 | 0.9 | 0.6 | 2.7 | |
| part by | hydroxyalkylalkyl | | HEMC | | | | | | | 0.9 | 1.8 |
| weigh) | cellulose | | | | | | | | | | |
| | (I):(H) | | Weight | 60.0:40.0 | 70.0:30.0 | 80.0:20.0 | 70.0:30.0 | 90.0:10.0 | 70.0:30.0 | 70.0:30.0 | 70.0:30.0 |
| | | | ratio | | | | | | | | |
| | (I) + (II) Total | | | 3.0 | 3.0 | 3.0 | 3.0 | 6.0 | 9.0 | 3.0 | 6.0 |
| | (III) Cement | | | 35.0 | 35.0 | 35.0 | 35.0 | 35.0 | 35.0 | 35.0 | 35.0 |
| | (IV) Aggregate | | Silica stone | 44.0 | 44.0 | 44.0 | 44.0 | 44.0 | 44.0 | 44.0 | 44.0 |
| | | | powder | | | | | | | | |
| | | | Pearlite | 15.0 | 15.0 | 15.0 | 15.0 | 15.0 | 15.0 | 15.0 | 15.0 |
| | (III):(IV) | | Weight | 37.2:62.8 | 37.2:62.8 | 37.2:62.8 | 37.2:62.8 | 37.2:62.8 | 37.2:62.8 | 37.2:62.8 | 37.2:62.8 |
| | | | ratio | | | | | | | | |
| | (V) Reinforcing | | Hardwood | 5.0 | 5.0 | 5.0 | 5.0 | 5.0 | 5.0 | 5.0 | 5.0 |
| | fibers | | pulp fibers | | | | | | | | |
| | | | Polypro- | 1.0 | 1.0 | 1.0 | 1.0 | 1.0 | 1.0 | 1.0 | 1.0 |
| | | | pylene | | | | | | | | |
| | | | fibers | | | | | | | | |
| | (III) + (IV) + (V) Total | | | 100 | 100 | 100 | 100 | 100 | 100 | 100 | 100 |
| | (VI) Water | | | 45.0 | 45.0 | 45.0 | 45.0 | 45.0 | 45.0 | 45.0 | 45.0 |
| Evaluation | Hydraulic | Extrusion | Cracks | None | None | None | None | None | None | None | None |
| result | compo- | moldability | Meander- | None | None | None | None | None | None | None | None |
| | sition | | ing | | | | | | | | |

| | | | | | | | | | |
|---|---|---|---|---|---|---|---|---|---|
| Extrusion- | Pot life (hour) | 4.5 | 4.5 | 3.5 | 4.5 | 4.5 | 4.5 | 5.0 | 4.5 |
| molded | Curing time (hour) | 7.5 | 7.5 | 7.5 | 7.5 | 6.5 | 7.0 | 7.5 | 7.0 |
| part | | | | | | | | | |
| Extrusion- | Bending strength | 14.6 | 14.8 | 14.4 | 14.5 | 14.3 | 14.8 | 14.5 | 14.9 |
| molded | (N/mm²) | | | | | | | | |
| body | Water content | 0 | 0 | 0 | 0 | 0 | 0 | 0 | 0 |
| | (% by weight) | | | | | | | | |

| | | | | Example | | | Comparative Example | | | |
|---|---|---|---|---|---|---|---|---|---|---|
| | | | | 9 | 10 | 11 | 1 | 2 | 3 | 4 |
| Hydraulic | (I) Expansive | | A | 8.1 | | | 1.4 | | | |
| compo- | additive | | B | | 1.8 | 2.1 | | 1.4 | | |
| sition | (II) Water-soluble | | HPMC | | | | 1.6 | | 3.0 | |
| part by | hydroxyalkylalkyl | | HEMC | 0.9 | 1.2 | 0.9 | | 1.6 | | 3.0 |
| weigh) | cellulose | | | | | | | | | |
| | (I):(II) | | Weight ratio | 90.0:10.0 | 60.0:40.0 | 70.0:30.0 | 46.7:53.3 | 46.7:53.3 | 0:100 | 0:100 |
| | (I) + (II) Total | | | 9.0 | 3.0 | 3.0 | 3.0 | 3.0 | 3.0 | 3.0 |
| | (III) Cement | | | 35.0 | 35.0 | 35.0 | 35.0 | 35.0 | 35.0 | 35.0 |
| | (IV) Aggregate | | Silica stone | 44.0 | 44.0 | 44.0 | 44.0 | 44.0 | 44.0 | 44.0 |
| | | | powder | | | | | | | |
| | | | Pearlite | 15.0 | 15.0 | 15.0 | 15.0 | 15.0 | 15.0 | 15.0 |
| | (III):(IV) | | Weight ratio | 37.2:62.8 | 37.2:62.8 | 37.2:62.8 | 37.2:62.8 | 37.2:62.8 | 37.2:62.8 | 37.2:62 8 |
| | (V) Reinforcing | | Hardwood | 5.0 | 5.0 | 5.0 | 5.0 | 5.0 | 5.0 | 5.0 |
| | fibers | | pulp fibers | | | | | | | |
| | | | Polypropylene | 1.0 | 1.0 | 1.0 | 1.0 | 1.0 | 1.0 | 1.0 |
| | | | fibers | | | | | | | |
| | (III) + (IV) + (V) Total | | | 100 | 100 | 100 | 100 | 100 | 100 | 100 |
| | (VI) Water | | | 45.0 | 45.0 | 45.0 | 45.0 | 45.0 | 45.0 | 45.0 |
| Evaluation | Hydraulic | Extrusion | Cracks | None | None | None | None | None | None | None |
| result | compo- | moldability | Meander- | None | None | None | None | None | None | None |
| | sition | | ing | | | | | | | |

| | | | | | | | | |
|---|---|---|---|---|---|---|---|---|
| Extrusion- | Pot life (hour) | 4.0 | 5.0 | 5.0 | 4.5 | 4.5 | 4.5 | 4.5 |
| molded | Curing time (hour) | 6.5 | 7.0 | 7.0 | 9.0 | 10.0 | 9.0 | 10.0 |
| part | | | | | | | | |
| Extrusion- | Bending strength (N/mm²) | 14.5 | 14.9 | 14.6 | 14.0 | 13.9 | 14.2 | 13.8 |
| molded | Water content | 0 | 0 | 0 | 0 | 0 | 0 | 0 |
| body | (% by weight) | | | | | | | |

From Examples 1 to 11 and Comparative Examples 1 to 4, it has been found that the curing time can be shortened without impairing the pot life by using an expansive additive having a predetermined ratio with respect to the water-soluble hydroxyalkylalkyl cellulose in the extrusion molding hydraulic composition containing the water-soluble hydroxyalkylalkyl cellulose.

In addition, from Examples 1 to 3, it has been found that the similar effects can be obtained even by changing the weight ratio between the expansive additive and the water-soluble hydroxyalkylalkyl cellulose.

In addition, from Examples 4 to 11, it has been found that the similar effects can be obtained even by a combination of different types of expansive additive and water-soluble hydroxyalkylalkyl cellulose from those of Examples 1 to 3.

In addition, the strength of each of the obtained extrusion-molded bodies was not impaired as compared with that in Comparative Examples.

Japanese Patent Application No. 2020-021518 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An extrusion molding hydraulic composition comprising: an expansive additive; a water-soluble hydroxyalkylalkyl cellulose; cement; an aggregate; reinforcing fibers; and water, wherein a weight ratio of the expansive additive to the water-soluble hydroxyalkylalkyl cellulose is 50:50 to 99:1.

2. The extrusion molding hydraulic composition according to claim 1, wherein the expansive additive is an ettringite-based expansive additive or a lime-based expansive additive.

3. The extrusion molding hydraulic composition according to claim 1, wherein the water-soluble hydroxyalkylalkyl cellulose is hydroxypropylmethyl cellulose or hydroxyethylmethyl cellulose.

4. The extrusion molding hydraulic composition according to claim 1, wherein a total amount of the expansive additive and the water-soluble hydroxyalkylalkyl cellulose added is 0.5 to 15 parts by weight per 100 parts by weight of a total of the cement, the aggregate, and the reinforcing fibers.

5. A method for manufacturing an extrusion-molded body comprising the steps of: extrusion-molding the extrusion molding hydraulic composition according to claim 1 to obtain an extrusion-molded part; curing the extrusion-molded part to obtain a cured extrusion-molded part; and drying the cured extrusion-molded part to obtain an extrusion-molded body.

6. An extrusion-molded body comprising: an expansive additive; a water-soluble hydroxyalkylalkyl cellulose; cement; an aggregate; and reinforcing fibers.
